(19) United States
(12) Patent Application Publication
(10) Pub. No.: US 2015/0333683 A1
(43) Pub. Date: Nov. 19, 2015

(54) MOTOR CONTROL APPARATUS AND MOTOR CONTROL METHOD

(71) Applicant: NISSAN MOTOR CO., LTD., Yokohama-shi, Kanagawa (JP)

(72) Inventors: Shiho Usuda, Tokyo (JP); Takaaki Karikomi, Kanagawa (JP)

(73) Assignee: Nissan Motor Co., Ltd., Kanagawa (JP)

(21) Appl. No.: 14/655,229

(22) PCT Filed: Nov. 22, 2013
(86) PCT No.: PCT/JP2013/081536

§ 371 Date: Jun. 24, 2015

(30) Foreign Application Priority Data
Dec. 28, 2012 (JP) 2012-287752

(51) Int. Cl. H02P 23/00; H02P 27/06

(52) U.S. Cl. CPC H02P 23/004; H02P 27/06

(57) ABSTRACT

A motor control apparatus has an inverter that applies a voltage to an AC induction motor to be driven, a command value calculator that calculates a command value of an AC voltage outputted from the inverter based on a target motor torque of the AC induction motor, and an inverter controller that controls the inverter based on the command value of the AC voltage. The target motor torque of the AC induction motor includes a first target motor torque and a second target motor torque. A high speed response is required in the first target motor torque in order to at least suppress torsional vibration. The second target motor torque is a lower speed response than the first target motor torque. Delay processing is carried out for the second target motor torque.

### CROSS-REFERENCE TO RELATED APPLICATIONS

The present application is a national stage application of PCT Application No. PCT/JP2013/081536, filed claims priority to Japanese Patent Application No. 2012-287752, filed with the Japan Patent Office on Dec. 28, 2012, the entire content of which is expressly incorporated herein by reference.

### BACKGROUND

1. Technical Field

The present invention relates to a motor control apparatus and a motor control method.

2. Related Art

In “Practical motor drive control system design and its practice” edited by Haruo NAITO, pp. 191-230, a vector control for an induction motor, in which a motor torque is controlled by adjusting a magnetic flux current and a torque current obtained by converting a three-phase AC current, which is to flow to a stator of an induction motor, into an orthogonal biaxial coordinate system synchronized with a power source angular frequency (=motor electric angular frequency+slip angle frequency), is disclosed. In a case where the slip angle frequency is controlled so as to be in proportion to a ratio of the torque current and a rotor magnetic flux, an induction motor torque is in proportion to the product of the rotor magnetic flux, which is generated with delay from the magnetic flux current, and the orthogonal torque current. Further, since the respective axes are interfered with each other, a non-interference controller that cancels an interference term is provided in order to control them independently.

### SUMMARY OF THE INVENTION

In a case where the induction motor described in “Practical motor drive control system design and its practice” is applied to an electric vehicle, a transfer system for the torque, which leads to driving wheels from an output shaft of the motor via a drive shaft, constitutes a torsional resonance system in which the drive shaft is used as a spring element. For this reason, when an accelerator pedal is depressed rapidly at the time of quick start, quick acceleration or the like, for example, the torsional resonance system resonates due to an increase in this rapid output torque, and this may cause vehicle body vibration.

One or more embodiments of the present invention provides a motor control apparatus and a motor control method for suppressing torsional vibration.

A motor control apparatus according to one or more embodiments of the present invention includes: an inverter configured to apply a voltage to an AC induction motor to be driven; a command value calculator configured to calculate a command value of an AC voltage outputted from the inverter on the basis of a target motor torque of the AC induction motor; and an inverter controller configured to control the inverter on the basis of the command value of the AC voltage. The target motor torque of the AC induction motor includes a first target motor torque and a second target motor torque in which a high speed response is required in the first target motor torque in order to at least suppress torsional vibration, the second target motor torque is a lower speed response than the first target motor torque, and delay processing is carried out for the second target motor torque. The command value calculator calculates, on the basis of the target motor torque, a magnetic flux current command value in which current responsiveness is slow with respect to an input, and the command value calculator calculates, on the basis of the target motor torque and the magnetic flux current command value, a torque current command value in which current responsiveness is quicker than that of the magnetic flux current command value.

Embodiments of the present invention will be described below in detail with reference to the accompanying drawings.

### BRIEF DESCRIPTION OF THE DRAWINGS

FIG. 1 is a block diagram showing a configuration of a motor control apparatus according to a first embodiment.

FIG. 2 is a drawing for explaining processing content carried out by a torque response improving arithmetic unit.

FIG. 3 is a drawing showing another configuration example of the torque response improving arithmetic unit.

FIG. 4 is a drawing showing still another configuration example of a current command value arithmetic unit and the torque response improving arithmetic unit.

FIGS. 5(a)-5(j) show a controlled result of the motor control apparatus shown in FIG. 1 according to the first embodiment.

FIGS. 6(a)-6(j) show a controlled result of a conventional motor control apparatus, in which a target motor torque is not divided into two of T₁* and T₂* and no torque response improving arithmetic unit and no filter are provided in the configuration shown in FIG. 1.

FIG. 7 is a block diagram showing a configuration of the case where the motor control apparatus is applied to a field-winding synchronous motor in which winding for causing a field current to flow is wound around the rotor.

FIG. 8 is a drawing for explaining processing content carried out by the torque response improving arithmetic unit with a configuration shown in FIG. 7.

FIG. 9 is a drawing showing another configuration example of the torque response improving arithmetic unit with the configuration shown in FIG. 7.

FIGS. 10(a)-10(j) show a controlled result of the motor control apparatus with the configuration shown in FIG. 7.

FIGS. 11(a)-11(j) show a controlled result of the conventional motor control apparatus, in which the target motor torque is not divided into two of T₁* and T₂* and no torque response improving arithmetic unit and no filter are provided in the configuration shown in FIG. 7.

FIG. 12 is a block diagram showing a main configuration of a motor control apparatus according to a second embodiment, which corresponds to FIG. 2 in the first embodiment.

FIGS. 13(a)-13(j) show a controlled result of the motor control apparatus according to the second embodiment.

FIG. 14 is a block diagram showing a configuration of the case where a γ-axis current command value i_{γs}* outputted from a torque response improving arithmetic unit is limited to an upper limit value i_{γs}_{_{—}}ₗᵢₘ by a limiter.

FIG. 15 is a block diagram showing a configuration of the case where a limiter is provided in the configuration shown in FIG. 4.

FIG. 16 is a block diagram showing a main configuration of a motor control apparatus according to a third embodiment.

FIGS. 17(a)-17(j) show a controlled result of the motor control apparatus according to the third embodiment.

FIG. 18 is a block diagram showing a configuration of the case where a lower limit limiter is provided in the configuration shown in FIG. 4.

FIG. 19 is a block diagram showing a configuration of the case where a lower limit limiter is provided in the configuration of the field-winding synchronous motor shown in FIG. 9.

FIG. 20 is a block diagram showing a configuration of the case where a lower limit limiter is provided in another configuration of the field-winding synchronous motor.

FIGS. 21(a)-21(j) show a controlled result of the case where the field-winding motor is configured to output a field current i_{f}* with a slow response by a predetermined amount even though the torque command value T₁* is zero or in the vicinity of zero.

### DETAILED DESCRIPTION

Embodiments of the present invention will be described below with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### First Embodiment

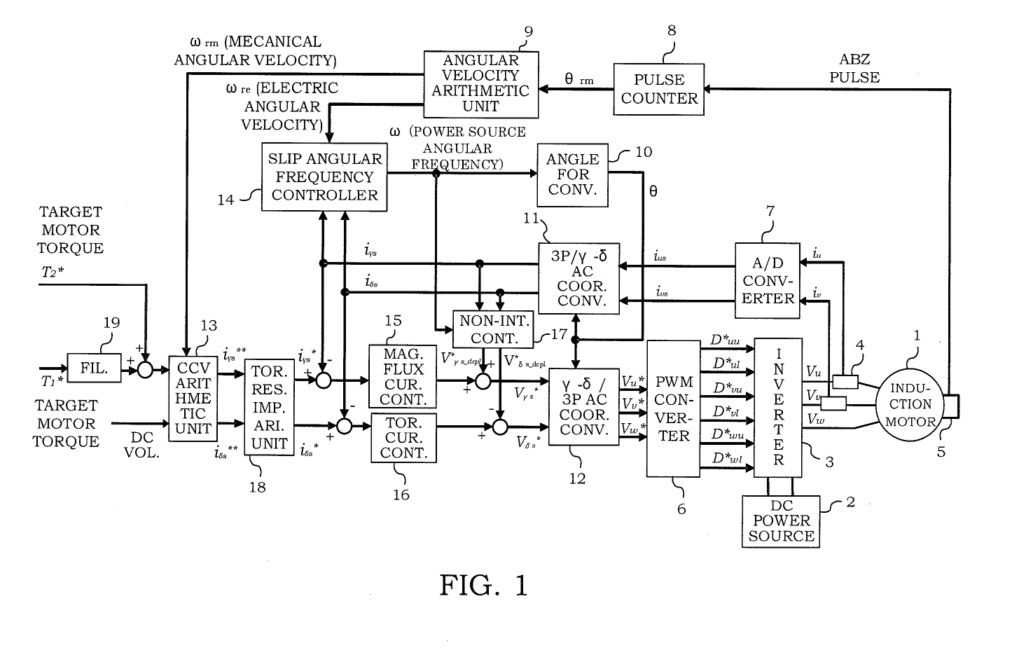

FIG. 1 is a block diagram showing a configuration of a motor control apparatus according to a first embodiment. This motor control apparatus is applied to an electric vehicle, for example. It should be noted that the motor control apparatus can be applied to a hybrid vehicle or a system other than a vehicle, for example, in addition to the electric vehicle.

A motor 1 is a three-phase AC induction motor. In a case where the motor control apparatus is applied to an electric vehicle, the motor 1 becomes a driving source of the vehicle.

A PWM convertor 6 generates PWM_Duty driving signals Dᵤᵤ*, Dᵤₗ*, Dᵥᵤ*, Dᵥₗ*, D_{wu}*, D_{wl}* for switching elements (such as an IGBT) in a three-phase voltage type inverter 3 on the basis of three-phase voltage command values Vᵤ*, Vᵥ*, V_{w}*.

The inverter 3 converts a DC voltage of a DC power source 2 into AC voltages Vᵤ, Vᵥ, V_{w} on the basis of the driving signals generated by the PWM convertor 6, and supplies the AC voltages to the motor 1. The DC power source 2 is a stacked lithium ion battery, for example.

A current sensor 4 detects a current of each of at least two phases (for example, U-phase current iᵤ, V-phase current iᵥ) of three-phase AC currents supplied to the motor 1 from the inverter 3. The detected currents iᵤ, iᵥ of the two phases are converted into digital signals iᵤₛ, iᵥₛ by an A/D converter 7, and are inputted into a three-phase/γ-δ AC coordinate converter 11. In a case where the current sensors 4 are installed for only the two phases, a current i_{ws} of the remaining one phase can be obtained on the basis of the following formula (1).

[Formula 1]

i_{ws}=−iᵤₛ−iᵥₛ (1)

A magnetic pole position sensor 5 outputs a A-phase pulse, a B-phase pulse and a Z-phase pulse according to a rotor position (angle) of the motor 1, and a rotor mechanical angle θᵣₘ is obtained through a pulse counter 8. The rotor mechanical angle θᵣₘ is inputted to an angular velocity arithmetic unit 9, and the angular velocity arithmetic unit 9 obtains, on the basis of a time change rate of the rotor mechanical angle θᵣₘ, a rotor mechanical angular velocity ωᵣₘ, and obtains a rotor electric angular velocity ωᵣₑ by multiplying the rotor mechanical angular velocity ωᵣₘ by a motor pole-pair number p.

A γ-δ/three-phase AC coordinate converter 12 carries out conversion from an orthogonal biaxial DC coordinate system (γ-δ axes) that rotates with a power source angular velocity ω (will be described later) into a three-phase AC coordinate system (UVW axes). More specifically, a γ-axis voltage command value (magnetic flux voltage command value) V_{γs}* and a δ-axis voltage command value (torque voltage command value) V_{δs}*, and a power source angle δ obtained by integrating the power source angular velocity ω are inputted to the γ-δ/three-phase AC coordinate converter 12, and the γ-δ/three-phase AC coordinate converter 12 carries out coordinate transforming processing based on the following formula (2) to calculate and output the voltage command values Vᵤ*, Vᵥ*, V_{w} of the respective UVW phases. Here, θ′ in the formula (2) is the same as θ.

$$\begin{matrix}[ Formula 2 ] & \\ [ \begin{matrix}{v}_{u}^{*} \\ {v}_{v}^{*} \\ {v}_{w}^{*}\end{matrix} ] = \sqrt{\frac{2}{3}} [ \begin{matrix}1 & 0 \\ - \frac{1}{2} & \frac{\sqrt{3}}{2} \\ - \frac{1}{2} & - \frac{\sqrt{3}}{2}\end{matrix} ] [ \begin{matrix}cos {θ}^{′} & - sin {θ}^{′} \\ sin {θ}^{′} & cos {θ}^{′}\end{matrix} ] [ \begin{matrix}{v}_{γ}^{*} \\ {v}_{δ}^{*}\end{matrix} ] & ( 2 )\end{matrix}$$

The three-phase/γ-δ AC coordinate converter 11 carries out conversion from a three-phase AC coordinate system (UVW axes) into an orthogonal biaxial DC coordinate system (γ-δ axes). More specifically, a U-phase current iᵤₛ, a V-phase current iᵥₛ and a W-phase current i_{ws}, and the power source angle θ obtained by integrating the power source angular velocity ω are inputted to the three-phase/γ-δ AC coordinate converter 11, and the three-phase/γ-δ AC coordinate converter 11 calculates a γ-axis current (magnetic flux current) i_{γs} and a δ-axis current (torque current) i_{δs} on the basis of the following formula (3). A response of the γ-axis current with respect to the command value is slow, but a response of the δ-axis current with respect to the command value is quick compared with the γ-axis current.

$$\begin{matrix}[ Formula 3 ] & \\ [ \begin{matrix}{i}_{γ} \\ {i}_{δ}\end{matrix} ] = [ \begin{matrix}cos θ & sin θ \\ - sin θ & cos θ\end{matrix} ] \sqrt{\frac{2}{3}} [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{i}_{us} \\ {i}_{vs} \\ {i}_{ws}\end{matrix} ] & ( 3 )\end{matrix}$$

A target motor torque, a motor rotation number (the mechanical angular velocity ωᵣₘ) and a DC voltage Vdc of the DC power source 2 are inputted to a current command value arithmetic unit 13, and the current command value arithmetic unit 13 calculates a γ-axis current command value (the magnetic flux current command value) i_{γs}** and δ-axis current command value (the torque current command value) i_{δs}**. Each of the γ-axis current command value i_{γs}** and the δ-axis current command value i_{δs}** can be obtained by storing map data, which define a relationship between a group of the target motor torque, the motor rotation number (the mechanical angular velocity ωᵣₘ) and the DC voltage V_{dc} and a group of the γ-axis current command value i_{γs}** and the δ-axis current command value i_{δs}**, in a memory in advance and referring to these map data.

Here, the target motor torque inputted to the current command value arithmetic unit 13 is a torque obtained by adding a target motor torque T1*, for which time delay processing was carried out by a filter 19, to a target motor torque T2*. The target motor torque T1* is a torque command value obtained in accordance with an accelerator opening degree, and a high speed response is not required. The target motor torque T2* is a torque command value for which a high speed response is required in order to suppress torsional vibration of a driving force transfer system (drive shaft) that leads to driving wheels from the motor 1.

The filter 19 outputs the target motor torque T1* so as to be delayed at least for a period of time longer than a response time of the target motor torque T1* that is defined in accordance with the accelerator opening degree.

The γ-axis current (magnetic flux current) i_{γs}, the δ-axis current (torque current) i_{δs} and a power source angular frequency ω are inputted to a non-interference controller 17, and the non-interference controller 17 calculates non-interference voltages V*_{γs}_{_{—}}_{dcpl}, V*_{δs}_{_{—}}_{dcpl}, which are required to cancel (or offset) an interference voltage between the γ-δ orthogonal coordinate axes, on the basis of the following formula (4).

$$\begin{matrix}{v}_{γ s \_ d cp l}^{*} = - ω \cdot σ \cdot {L}_{s} \cdot {i}_{δ s} & [ Formula 4 ] \\ {v}_{δ s \_ dcpl}^{*} = ω \cdot ( σ \cdot {L}_{s} \cdot {i}_{γ s} + \frac{M}{{L}_{r}} {φ}_{γ r} ) & \\ {φ}_{γ r} = \frac{M}{τ \cdot s + 1} \cdot {i}_{γ s} & \end{matrix}$$

ω power source angular velocity
M mutual inductance
Lₛ: stator side self-inductance Lᵣ: rotor side self-inductance

$$σ = 1 - \frac{{M}^{2}}{{L}_{s} \cdot {L}_{r}} \text{:} leakage c oefficient$$

Here, τ in the formula (4) denotes a time constant of a rotor magnetic flux, and it is a very large value compared with a time constant of a current response. Further, s denotes a Laplace operator.

A magnetic flux current controller 15 causes a γ-axis current command value (the magnetic flux current command value) i_{γs}* to follow the measured γ-axis current (magnetic flux current) i_{γs} at desired responsiveness without steady-state deviation. Further, a torque current controller 16 causes a δ-axis current command value (torque current command value) i_{δs}* to follow the measured δ-axis current (torque current) i_{δs} at desired responsiveness without steady-state deviation. If a control to cancel an interference voltage between the γ-δ orthogonal coordinate axes by means of the non-interference controller 17 functions ideally, it becomes a simple control target characteristic with one input and one output. For this reason, it is possible to achieve this control with a simple PI feedback compensator. Values obtained by correcting (or adding) the respective voltage command values, which are outputs of the magnetic flux current controller 15 and the torque current controller 16 using non-interference voltages V_{γs}_{_{—}}_{dcpl}, V_{δs}_{_{—}}_{dcpl}, which are outputs of the non-interference controller 17, are set to the γ-axis voltage command value (magnetic flux voltage command value) V_{γs}* and the δ-axis voltage command value (torque voltage command value) V_{δs}*.

The γ-axis current (magnetic flux current) i_{γs} and the δ-axis current (torque current) i_{δs} are inputted to a slip angle frequency controller 14, and the slip angle frequency controller 14 calculates a slip angular velocity ωₛₑ on the basis of the following formula (5). Here, Rᵣ and Lᵣ are parameters of the induction motor, and respectively denote rotor resistance and rotor self-inductance.

$$\begin{matrix}[ Formula 5 ] & \\ {ω}_{se} = \frac{M \cdot {R}_{r}}{{L}_{r}} \cdot \frac{{i}_{δ s}^{*}}{{φ}_{γ r}} & ( 5 )\end{matrix}$$

A value obtained by adding the slip angular velocity ωₛₑ to the rotor electric angular velocity ωᵣₑ is set to the power source angular velocity ω. By carrying out this slip angle frequency control, an induction motor torque is in proportion to the product of the γ-axis current (magnetic flux current) i_{γs} and the δ-axis current (torque current) i_{δs}.

The control content carried out by a torque response improving arithmetic unit 18 will be described below.

A torque formula of a general induction motor is expressed by the following formula (6). Here, Kr in the formula (6) denotes a coefficient determined by a parameter of the induction motor.

[Formula 6]

T*=K_{T}·(i_{δs}*·\hat{φ}_{γr}−i_{γs}*·\hat{φ}_{δr}) (6)

Here, by controlling the slip angle frequency as shown in the formula (5), Φ̂_{δγ} can be set to zero (Φ̂_{δγ}=0). Therefore, the torque formula can be expressed as a formula (7) by means of a slip angle frequency control.

$$\begin{matrix}[ Formula 7 ] & \\ {T}^{*} = {K}_{T} \cdot {i}_{δ s}^{*} \cdot {\hat{φ}}_{γ r} \\ where {\hat{φ}}_{γ r} = \frac{M}{τ \cdot s + 1} \cdot {i}_{γ s}^{*} & ( 7 )\end{matrix}$$

Similarly, by carrying out a vector control, the torque formula can be dealt with as a formula (8).

[Formula 8]

T*=K_{T}·i_{γs}*·\hat{φ}_{δr} (8)

Although explanation based upon the formula (7) will be made below for simplification, similar effects can also be obtained by a similar configuration in the formula (8).

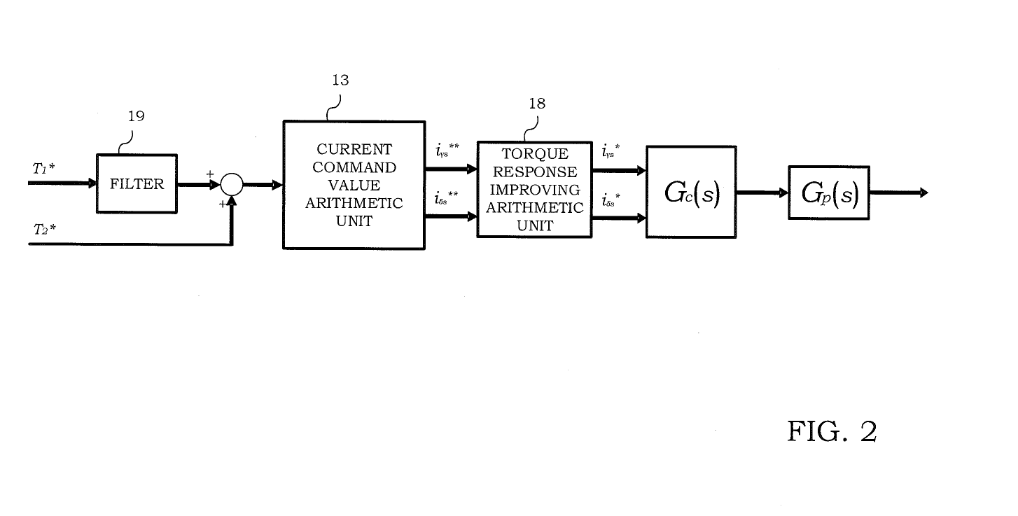

FIG. 2 is a drawing for explaining processing content carried out by the torque response improving arithmetic unit 18. The target motor torque T2* and the γ-axis current command value (the magnetic flux current command value) i_{γs}** with a slow response are inputted to the torque response improving arithmetic unit 18, and the torque response improving arithmetic unit 18 calculates a δ-axis current correction value i_{δs}_{_{—}}_{T2} on the basis of a formula (9) obtained by deforming the formula (7). The torque response improving arithmetic unit 18 calculates the δ-axis current command value (the torque current command value) i_{δs}* after correction by adding the calculated δ-axis current correction value i_{δs}_{_{—}}_{T2} to the δ-axis current command value (the torque current command value) i_{δs}** with a quick response. In this regard, the γ-axis current command value (the magnetic flux current command value) i_{γs}* outputted from the torque response improving arithmetic unit 18 is the same as the γ-axis current command value (the magnetic flux current command value) i_{γs}** inputted to the torque response improving arithmetic unit 18.

$$\begin{matrix}[ Formula 9 ] & \\ {i}_{δ {s \_ T}_{2}} = \frac{{T}_{2}^{*}}{{K}_{Te} \cdot {\hat{φ}}_{γ r}} \\ where {\hat{φ}}_{γ r} • \frac{M}{τ \cdot s + 1} \cdot {i}_{γ s}^{*} & ( 9 )\end{matrix}$$

In this regard, in FIG. 2, Gp(s) denotes the induction motor 1, and Gc(s) denotes a control model that expresses a control block that exists between the torque response improving arithmetic unit 18 and the induction motor 1.

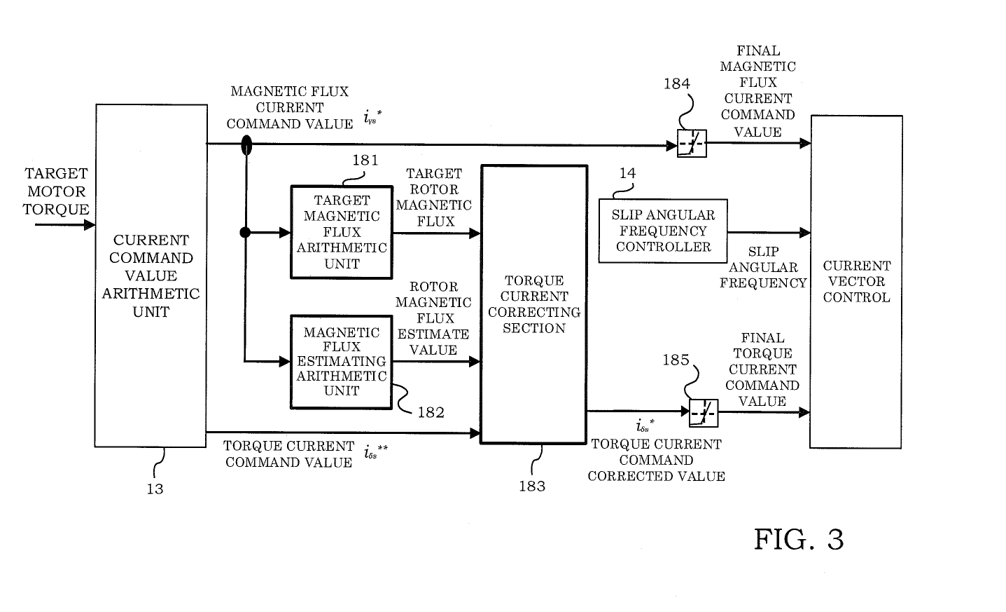

FIG. 3 is a drawing showing another configuration example of the torque response improving arithmetic unit 18. In the configuration shown in FIG. 3, the torque response improving arithmetic unit 18 includes a target magnetic flux arithmetic unit 181, a magnetic flux estimating arithmetic unit 182, and a torque current correcting section 183.

The target magnetic flux arithmetic unit 181 obtains a target rotor magnetic flux Φ*_{γr} on the basis of the following formula (10). Further, the magnetic flux estimating arithmetic unit 182 obtains a rotor magnetic flux estimate value Φ̂_{γr} on the basis of the following formula (11).

$$\begin{matrix}[ Formula 10 ] & \\ {φ}_{γ r}^{*} = {M}_{c} \cdot {i}_{γ s}^{*} & ( 10 ) \\ [ Formula 11 ] & \\ {φ}_{γ r}^{ \hat{}} = \frac{{M}_{c}}{τ \cdot s + 1} \cdot {i}_{γ s}^{*} & ( 11 )\end{matrix}$$

The torque current correcting section 183 obtains a δ-axis current command value (the torque current command value) i_{δs}* after correction on the basis of the target rotor magnetic flux Φ*_{γr} obtained by the target magnetic flux arithmetic unit 181 and the rotor magnetic flux estimate value Φ̂_{γr} obtained by the magnetic flux estimating arithmetic unit 182. For example, the δ-axis current command value i_{δs}* after correction is obtained by multiplying a ration of the target rotor magnetic flux Φ*_{γr} and the rotor magnetic flux estimate value Φ̂_{γr} by the δ-axis current command value i_{δs}**.

In this regard, an upper limit of the γ-axis current command value i_{γs}* is limited by an upper limit limiter 184, and an upper limit of the δ-axis current command value i_{δs}* is limited by an upper limit limiter 185.

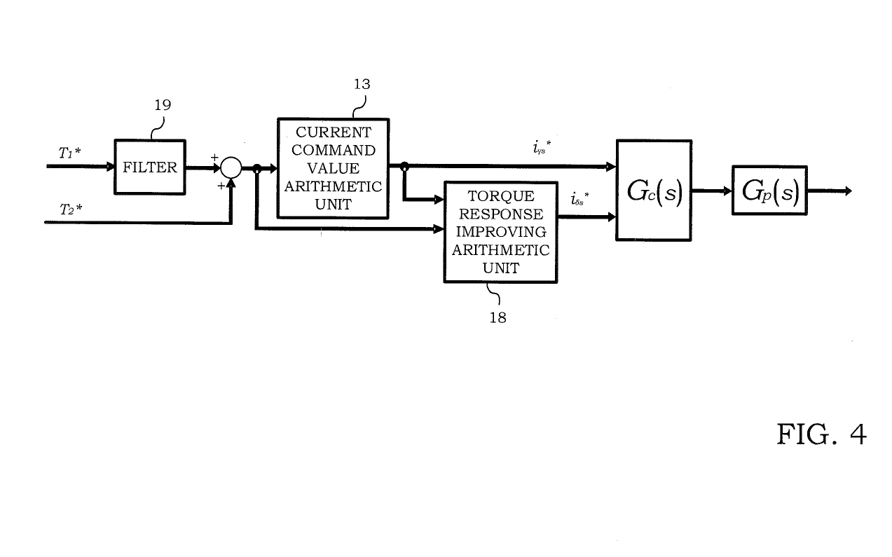

FIG. 4 is a drawing showing still another configuration example of the current command value arithmetic unit 13 and the torque response improving arithmetic unit 18. In FIG. 4, the target motor torque is inputted to the current command value arithmetic unit 13, and the current command value arithmetic unit 13 calculates a γ-axis current command value (the magnetic flux current command value) i_{γs}*. The target motor torque obtained by adding the target motor torque T1*, for which delay processing was carried out by the filter 19, to the target motor torque T2* and the γ-axis current command value i_{γs}* are inputted to the torque response improving arithmetic unit 18, and the torque response improving arithmetic unit 18 obtains the δ-axis current command value i_{δs}* on the basis of the following formula (12). Here, K_{Te} of the formula (12) is a coefficient determined by a parameter of the induction motor 1.

$$\begin{matrix}[ Formula 12 ] & \\ {i}_{δ s} = \frac{{T}_{1}^{*} + {T}_{2}^{*}}{{K}_{Te} \cdot {\hat{φ}}_{γ r}} \\ where {\hat{φ}}_{γ r} • \frac{M}{τ \cdot s + 1} \cdot {i}_{γ s}^{*} & ( 12 )\end{matrix}$$

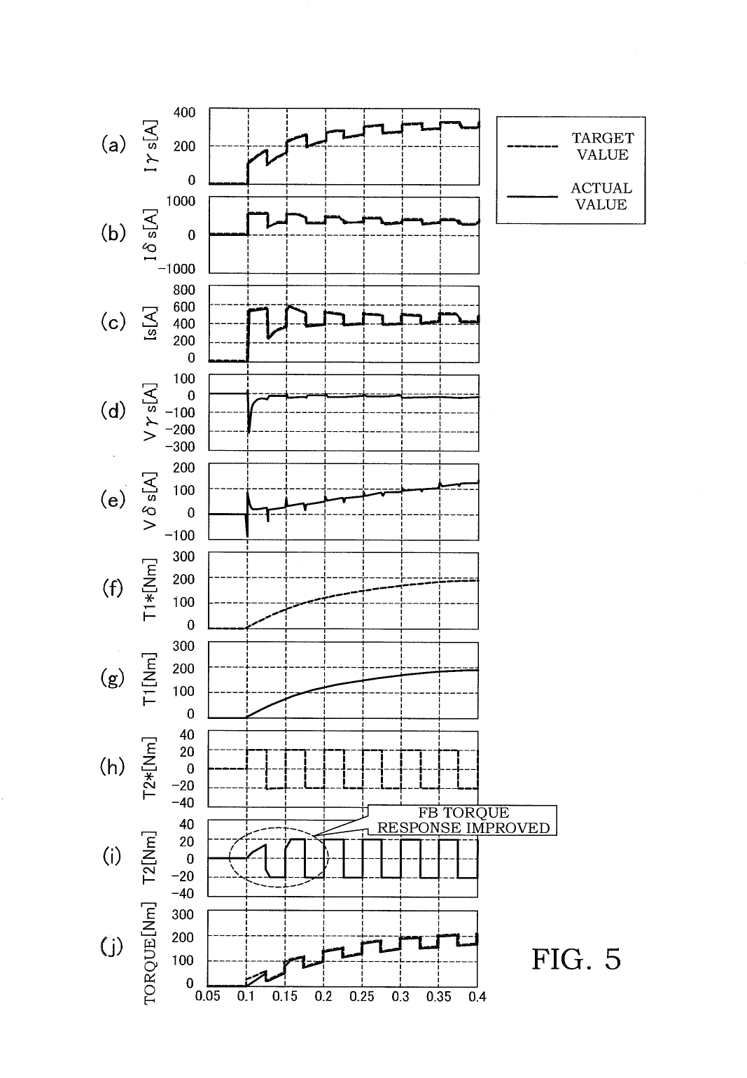

FIGS. 5(a)-5(j) show a controlled result of the motor control apparatus shown in FIG. 1 according to the first embodiment. FIGS. 5(a) to 5(j) respectively denote the γ-axis current i_{γs}, the δ-axis current i_{δs}, a current vector Is, a γ-axis voltage V_{γs}, a δ-axis voltage V_{δs}, a feedforward torque command value T₁*, a feedforward torque actual value T1, a feedback torque command value T2*, a feedback torque T₂, and a total torque.

In the first embodiment, since high response processing without a delay element is applied to the torque T₂* in which a high speed response is required (see FIGS. 5(h) and 5(i)), it is possible to achieve a desired torque. Further, by causing the torque T₁* in which the high speed response is not required to have a delay, it becomes hard to limit the current command value to a current limit value (upper limit value) with respect to the torque T₂* in which the high speed response is required. However, the current limit value is set so that a δ-axis current limit value becomes the same value as a γ-axis current limit value on the basis of the maximum permissible value Iₛ_{_{—}}ₘₐₓ of the current.

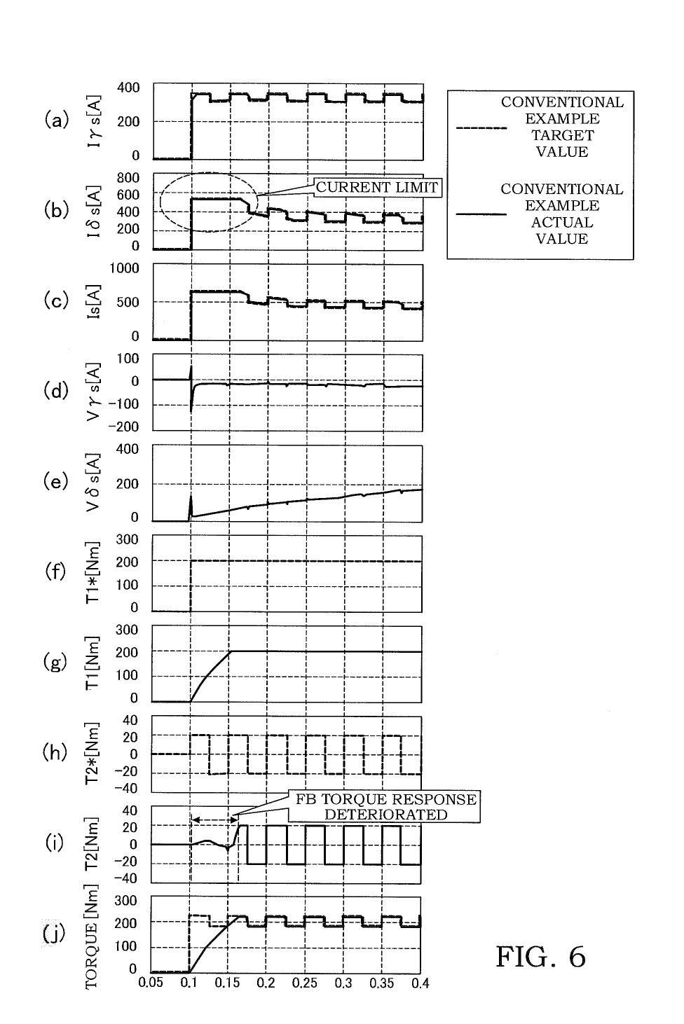

FIGS. 6(a)-6(j) show a controlled result of a conventional motor control apparatus, in which a target motor torque is not divided into two of T₁* and T₂* and no torque response improving arithmetic unit 18 and no filter 19 are provided in the configuration shown in FIG. 1. FIGS. 6(a) to 6(j) respectively denote the γ-axis current i_{γs}, the δ-axis current i_{δs}, the current vector Is, the γ-axis voltage V_{γs}, the δ-axis voltage V_{δs}, the feedforward torque command value T₁*, the feedforward torque actual value T₁, the feedback torque command value T₂*, the feedback torque T₂, and the total torque.

Since the δ-axis current is calculated in view of a delay of a γ-axis magnetic flux response, the δ-axis current is easily limited to the current limit value (upper limit value) when the γ-axis current is small or the torque command value is large (see FIG. 6(b)). In a case where the δ-axis current is limited to the current limit value, the feedback torque T₂ cannot follow the command value T₂* (see FIG. 6(i)), whereby the torque response becomes a gentle motion with respect to a target value (see FIG. 6(j)). Therefore, vibration, such as torsional vibration of the vehicle, cannot be suppressed per se because a delay of the γ-axis magnetic flux influences on the torque T₂ in which the quick response is required (see FIG. 6(i)). In this regard, a response for a torque T₁ that is determined on the basis of an accelerator operation of a driver may be slow, and there is no problem even though the response becomes gentle with respect to the target value (see FIG. 6(g)).

In this regard, since a motor parameter used when to calculate the δ-axis current command value or its correction value varies due to operation conditions, a parameter varying compensator for compensating this variation may be provided.

### Reference Configuration Example

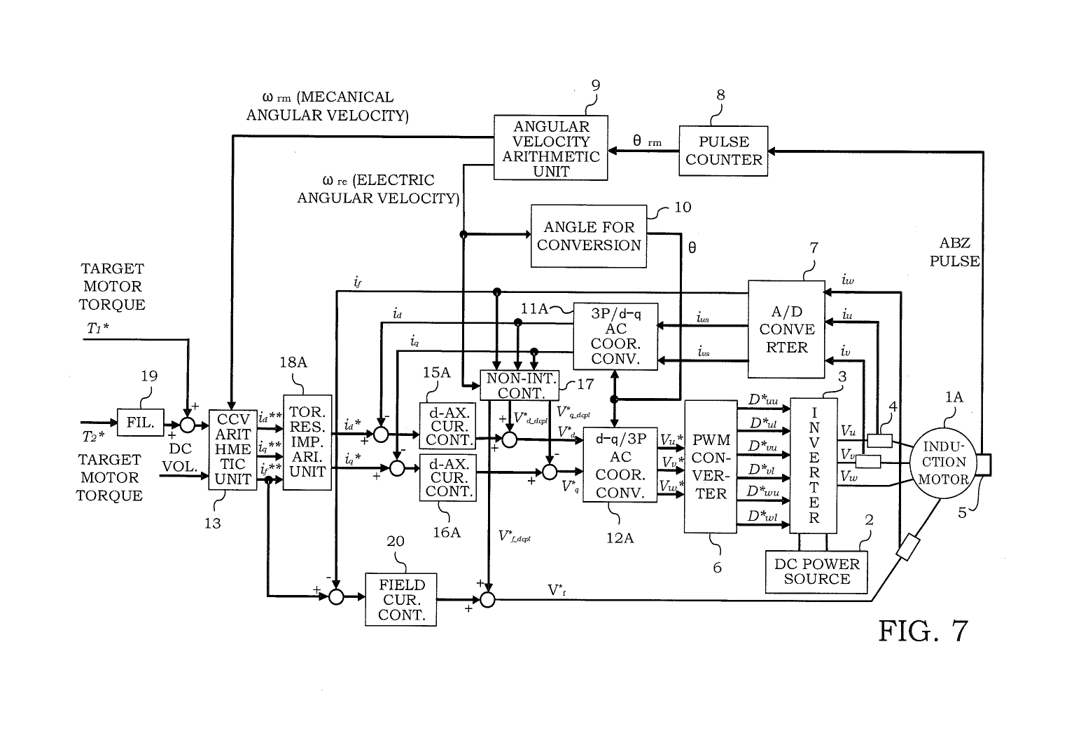

FIG. 7 is a block diagram showing a configuration of the case where the motor control apparatus is applied to a field-winding synchronous motor 1A in which winding for causing a field current to flow is wound around the rotor. The same reference numerals are provided to the same elements as those of the configuration shown in FIG. 1, and their detailed explanation will be omitted.

The configuration shown in FIG. 7 is different from the configuration shown in FIG. 1 in that a field current controller 20 is added and the slip angle frequency controller 14 is omitted. The torque response improving arithmetic unit 18A shown in FIG. 7 corresponds to the torque response improving arithmetic unit 18 shown in FIG. 1, a d-axis current controller 15A and a q-axis current controller 16A correspond to the magnetic flux current controller 15 and the torque current controller 16 shown in FIG. 1, respectively. Further, a three-phase/d-q AC coordinate converter 11A and a d-q/three-phase AC coordinate converter 12A correspond to the three-phase/γ-δ AC coordinate converter 11 and the γ-δ/three-phase AC coordinate converter 12 shown in FIG. 1, respectively.

The three-phase/d-q AC coordinate converter 11A carries out conversion from a three-phase AC coordinate system (UVW axes) into an orthogonal biaxial DC coordinate system (d-q axes). The d-q/three-phase AC coordinate converter 12A carries out conversion from the orthogonal biaxial DC coordinate system (d-q axes) into the three-phase AC coordinate system (UVW axes).

The d-axis current controller 15A causes a d-axis current command value i_{d}* to follow a measured d-axis current i_{d} at desired responsiveness without steady-state deviation. Further, the q-axis current controller 16A causes a q-axis current command value i_{q}* to follow a measured q-axis current i_{q} at desired responsiveness without steady-state deviation. The field current controller 20 causes a field current command value i_{f}* to follow a measured field current if at desired responsiveness without steady-state deviation.

The control content carried out by the torque response improving arithmetic unit 18A will be described below.

A torque formula of a general salient pole type field-winding motor is expressed by the following formula (13). Here, M denotes mutual inductance, L_{d} denotes d-axis self-inductance, L_{q} denotes q-axis self-inductance, and p denotes a pole-pair number.

[Formula 13]

T=p{M·i_{f}+(L_{d}−L_{q})·i_{d}}·_{iq} (13)

Further, in the case of a non-salient pole type field-winding motor, L_{d} is equal to L_{q}. For this reason, the torque formula is expressed by the following formula (14).

[Formula 14]

T=p·M·i_{f}·i_{q} (14)

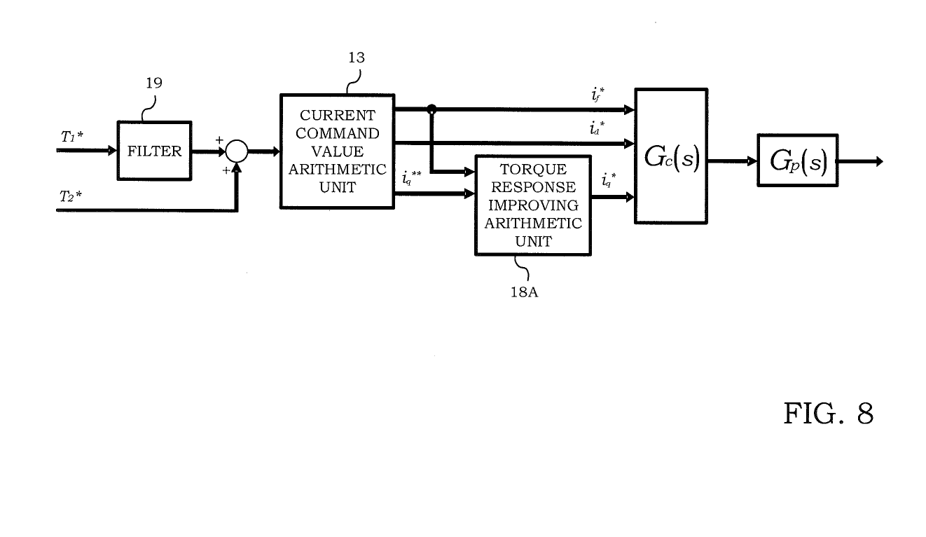

FIG. 8 is a drawing for explaining processing content carried out by the torque response improving arithmetic unit 18A. The torque response improving arithmetic unit 18A shown in FIG. 8 carries out the similar processing to that by the torque response improving arithmetic unit 18 as shown in FIG. 2. In this case, the γ-axis current command value i_{γs}** of FIG. 2 corresponds to the field current command value i_{f}* of FIG. 8, and the δ-axis current command value i_{δs}** of FIG. 2 corresponds to the q-axis current command value i_{q}** of FIG. 8.

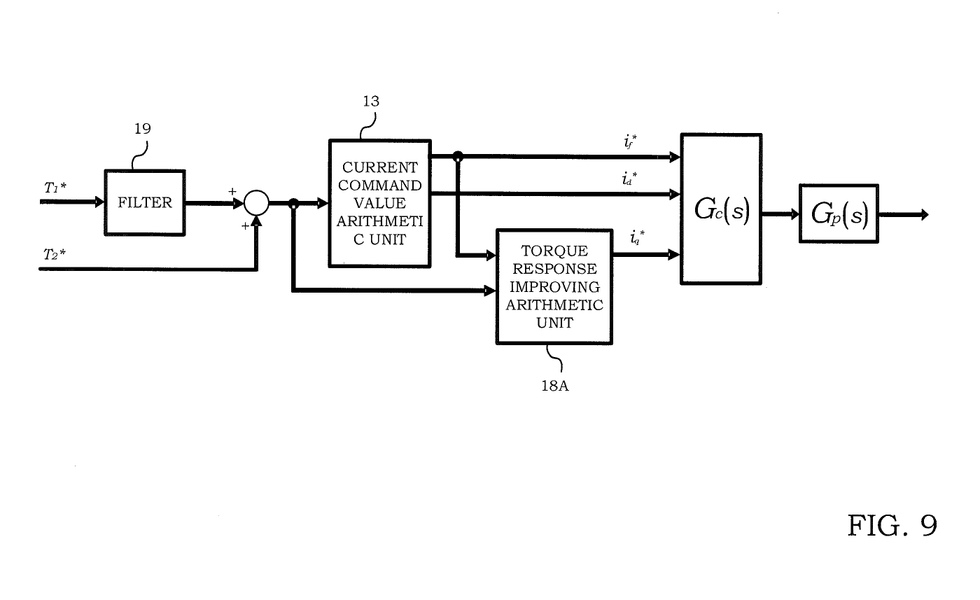

FIG. 9 is a drawing showing another configuration example of the torque response improving arithmetic unit 18A. In FIG. 9, the target motor torque obtained by adding the target motor torque T1*, for which delay processing was carried out by the filter 19, to the target motor torque T2* and the field current command value i_{f}* are inputted to the torque response improving arithmetic unit 18A, and the torque response improving arithmetic unit 18A obtains a δ-axis current command value i_{q}* on the basis of the following formula (15).

$$\begin{matrix}[ Formula 15 ] & \\ {i}_{q}^{*} = \frac{{T}_{1}^{*} + {T}_{2}^{*}}{p \cdot M \cdot {i}_{f}} & ( 15 )\end{matrix}$$

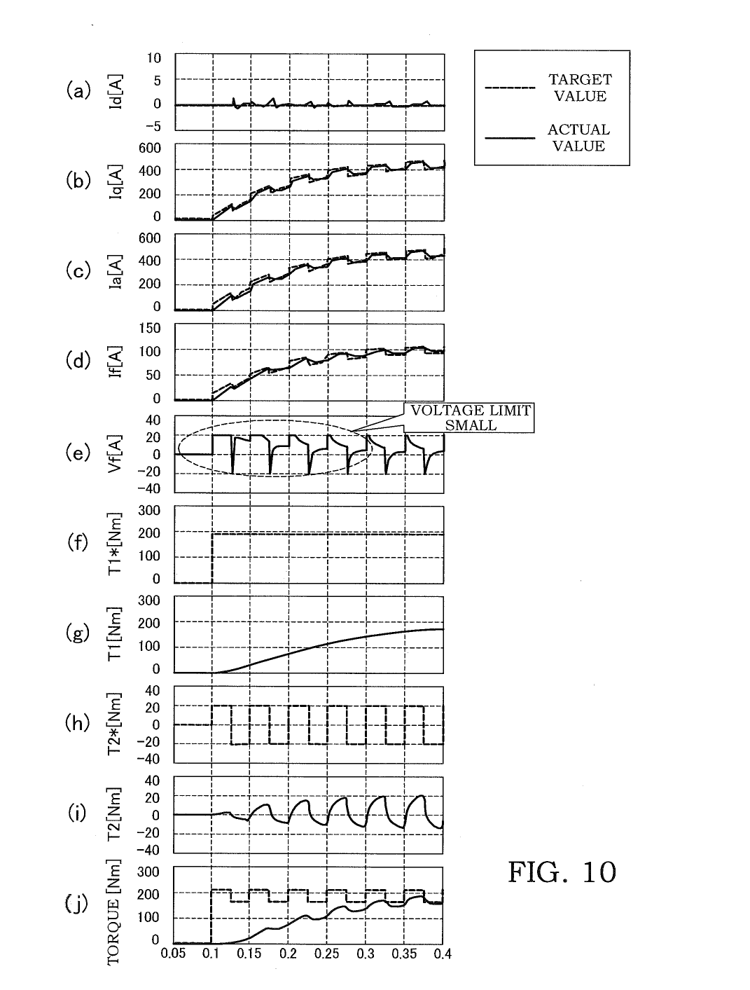

FIGS. 10(a)-10(j) show a controlled result of the motor control apparatus with the configuration shown in FIG. 7. FIGS. 10(a) to 10(j) respectively denote the d-axis current i_{d}, the q-axis current i_{q}, a current vector Ia, the field current I_{f}, a field voltage Vf, the feedforward torque command value T₁*, the feedforward torque actual value T1, the feedback torque command value T2*, the feedback torque T2, and the total torque.

As described above, since the high response processing without the delay element is applied to the torque T₂* in which the high speed response is required (see FIGS. 10(h) and 10(i)), it is possible to achieve the desired torque. Further, by causing the torque T₁* in which the high speed response is not required to have a delay, it is hard to limit the current command value to the current limit value (upper limit value) with respect to the torque T₂* in which the high speed response is required.

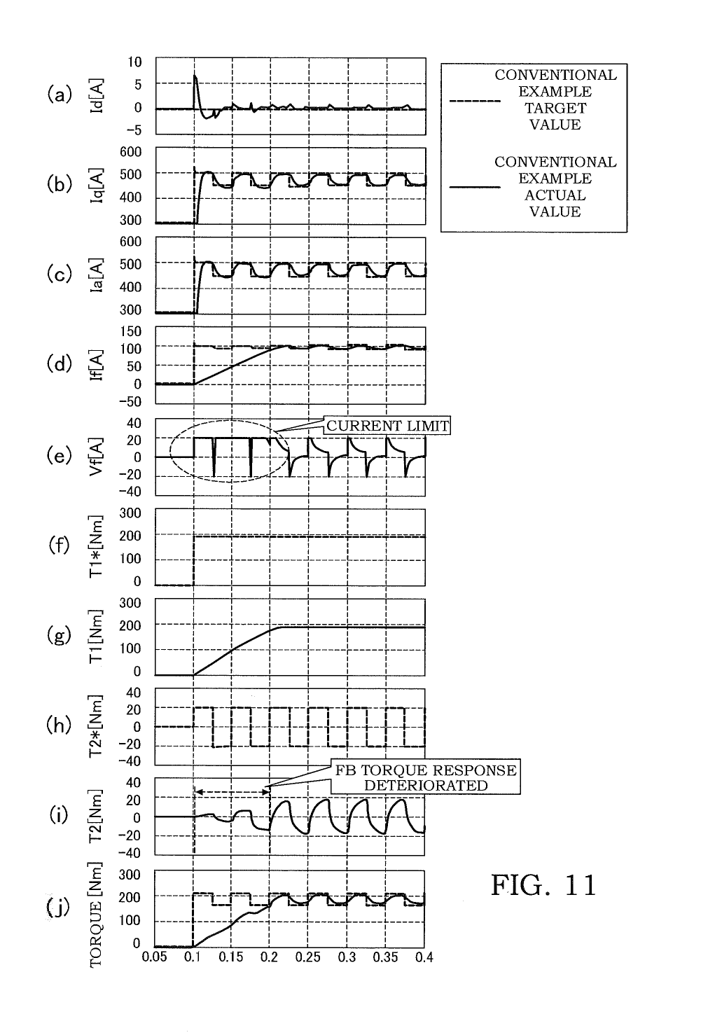

FIGS. 11(a)-11(j) show a controlled result of the conventional motor control apparatus, in which the target motor torque is not divided into two of T₁* and T₂* and no torque response improving arithmetic unit 18A and no filter 19 are provided in the configuration shown in FIG. 7. FIGS. 11(a) to 11(j) respectively denote the d-axis current i_{d}, the q-axis current the current vector Ia, the field current I_{f}, the field voltage Vf, the feedforward torque command value T₁*, the feedforward torque actual value T1, the feedback torque command value T2*, the feedback torque T2, and the total torque. In the configuration in which the torque response improving arithmetic unit 18A and the filter 19 are not provided, there is need to cause a response of the field current to become high responsiveness in order to cause the torque response to become high responsiveness. However, this causes a voltage peak of the field voltage Vf to become larger, and the current command value is limited to the upper limit value (see FIG. 11(e)). The response of the torque T₂, which is desired to become high responsiveness, cannot follow the target value while the field voltage Vf is limited to the upper limit value.

As described above, according to the motor control apparatus of the first embodiment, the motor control apparatus includes: the inverter 3 configured to apply the voltage to the AC induction motor 1 to be driven; the current command value arithmetic unit 13 and the torque response improving arithmetic unit 18 that function as a command value calculator configured to calculate the command value of the AC voltage outputted from the inverter 3 on the basis of the target motor torque of the AC the motor 1; and the magnetic flux current controller 15, the torque current controller 16 and the γ-δ/three-phase AC coordinate converter 12, and the PWM convertor 6 that function as an inverter controller configured to control the inverter 3 on the basis of the AC voltage command value. The target motor torque of the AC induction motor includes a first target motor torque T2* and a second target motor torque T1*, wherein a high speed response is required in the first target motor torque in order to at least suppress torsional vibration, the second target motor torque T1* is a lower speed response than the first target motor torque T2*, and delay processing is carried out for the second target motor torque T1*. The current command value arithmetic unit 13 and the torque response improving arithmetic unit 18 calculate a magnetic flux current command value i_{γs}**, in which current responsiveness with respect to the input is slow, on the basis of the target motor torque, and calculate the torque current command value i_{δs}*, in which current responsiveness is quicker than that of the magnetic flux current command value, on the basis of the target motor torque and the magnetic flux current command value i_{γs}**. The target motor torque includes the first target motor torque T2* and the second target motor torque T1* for which the delay processing is carried out, whereby it is possible to suppress vehicle body vibration by means of the first target motor torque T2*. For this reason, it is possible to improve a ride quality performance of occupants. Further, since the delay processing is carried out for the second target motor torque T1* with the low speed response, a current can be used for the first target motor torque T2*. For this reason, it becomes hard to limit the current command value to the current limit value (the upper limit value) with respect to the first target motor torque T₂* in which the high speed response is required, and this makes it possible to achieve the desired torque.

### Second Embodiment

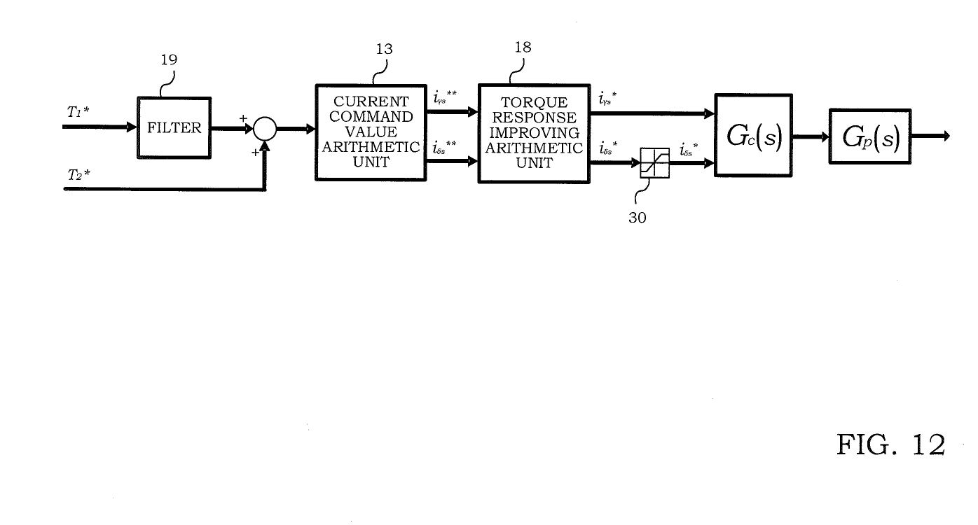

FIG. 12 is a block diagram showing a main configuration of a motor control apparatus according to a second embodiment, and corresponds to FIG. 2 in the first embodiment. As well as the configuration shown in FIG. 2, an induction motor is adopted as the motor 1. The same reference numerals are provided to the elements similar to the configuration shown in FIG. 2, and their detailed explanation will be omitted.

In the motor control apparatus according to the second embodiment, a limiter 30 is provided in the subsequent stage of the torque response improving arithmetic unit 18. The limiter 30 carries out processing to limit the δ-axis current command value i_{δs}* outputted from the torque response improving arithmetic unit 18 to an upper limit value i_{δs}_{_{—}}ₗᵢₘ. The upper limit value i_{δs}_{_{—}}ₗᵢₘ is expressed by the following formula (16) on the basis of the maximum value Iₛ_{_{—}}ₘₐₓ of the current of the motor 1 and the γ-axis current command value i_{γs}*.

[Formula 16]

i_{δs}_{_{—}}ₗᵢₘ={square root over (Iₛ_{_{—}}ₘₐₓ²−i_{γs}*²)} (16)

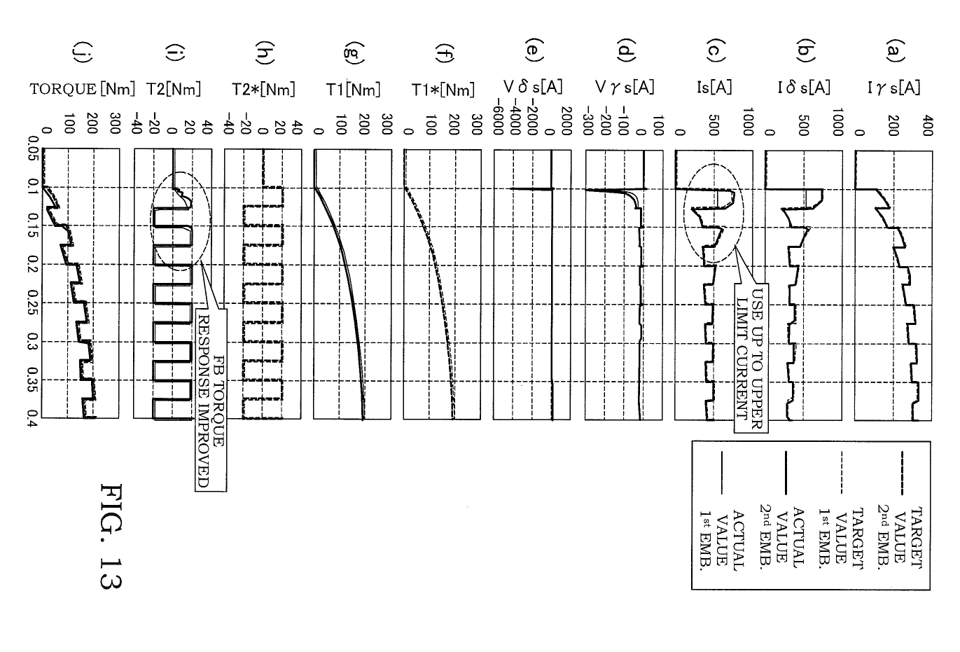

FIGS. 13(a)-13(j) show a controlled result of the motor control apparatus according to the second embodiment. However, for comparison, 13(a)-13(j) also show the controlled result of the motor control apparatus according to the first embodiment. FIGS. 13(a) to 13(j) respectively denote the γ-axis current i_{γs}, the δ-axis current i_{δs}, the current vector Is, the γ-axis voltage Vγs, the δ-axis voltage Vδs, the feedforward torque command value T₁*, the feedforward torque actual value T1, the feedback torque command value T2*, the feedback torque T2, and the total torque.

In the second embodiment, by limiting the δ-axis current command value to the upper limit value i_{δs}_{_{—}}ₗᵢₘ, it is possible to prevent excess or over current (see FIGS. 13(b) and 13(c)), and it is possible to achieve the torque response with the maximum current compared with the case of the first embodiment in which both of the γ-axis current and the δ-axis current are limited to the same quantity of the upper limit value.

The δ-axis current command value is not limited, but the γ-axis current command value may be limited. In this case, an upper limit value i_{γs}_{_{—}}ₗᵢₘ for limiting the γ-axis current command value is expressed by the following formula (17).

[Formula 17]

i_{γslim}={square root over (Iₛ_{_{—}}ₘₐₓ²−i_{δs}*²)} (17)

here ]i_{δs}*=i_{δs}**+i_{δs}_{_{—}}_{T2}

i_{δs}**: δ-axis current command value of T₁
i_{δs}_{_{—}}_{T2}: δ-axis current corrected value of T₁

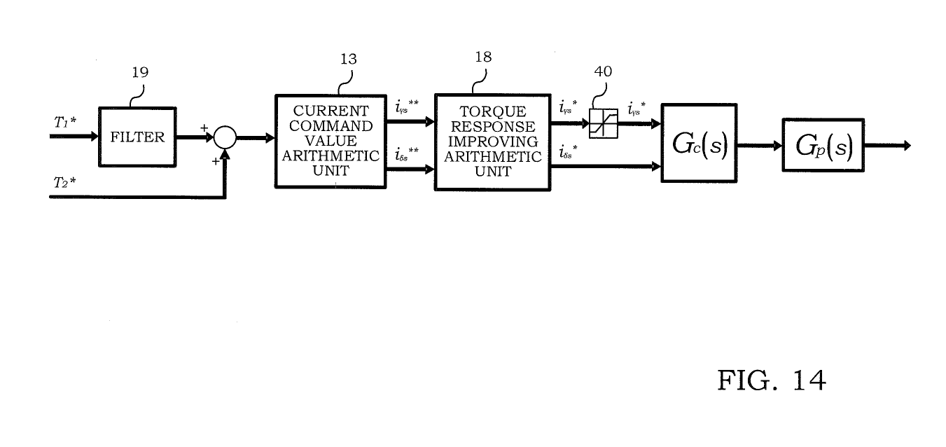

FIG. 14 is a block diagram showing a configuration of the case where the γ-axis current command value i_{γs}* outputted from the torque response improving arithmetic unit 18 is limited to the upper limit value i_{γs}_{_{—}}ₗᵢₘ by a limiter 40.

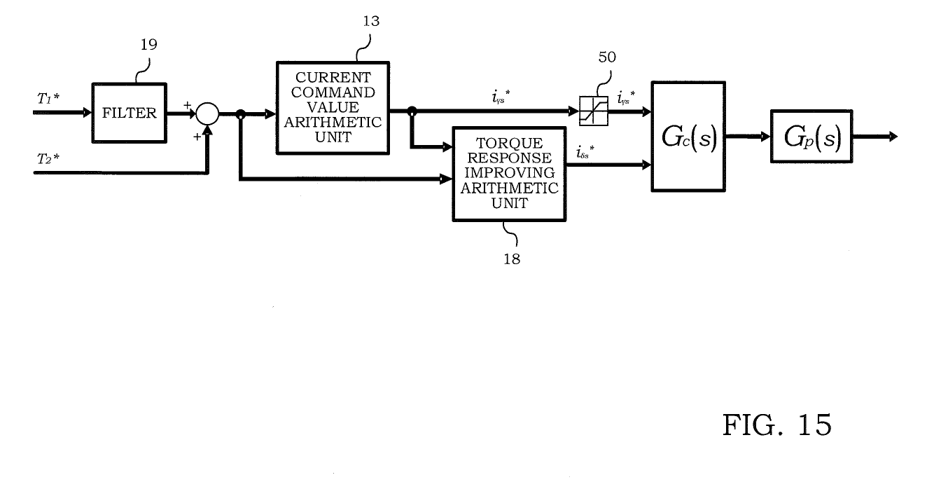

FIG. 15 is a block diagram showing a configuration of the case where a limiter 50 is provided in the configuration shown in FIG. 4. The limiter 50 limits the γ-axis current command value i_{γs}* outputted from the current command value arithmetic unit 13 to the upper limit value i_{γs}_{_{—}}ₗᵢₘ. In this regard, as well as FIG. 12, the δ-axis current command value may be limited to the upper limit value i_{δs}_{_{—}}ₗᵢₘ.

As described above, according to the motor control apparatus of the second embodiment, the limiter value is calculated on the basis of at least one of the δ-axis current command value i_{δs}* and the γ-axis current command value i_{γs}* and the maximum command value Iₛ_{_{—}}ₘₐₓ. The δ-axis current command value i_{δs}* or the γ-axis current command value i_{γs}* is limited on the basis of the calculated limiter value. For this reason, it is possible to prevent excess or over current. In addition, it is possible to achieve the torque response with the maximum current compared with the case where the command values of both the shafts are limited to the same quantity of a limit value.

### Third Embodiment

In a motor control apparatus according to a third embodiment, even though a target motor torque obtained by adding the target motor torque T1* for which the delay processing was carried out by the filter 19 to the target motor torque T₂* is zero or in the vicinity of zero (a predetermined torque or lower), a current to generate magnetic flux at the rotor side is outputted by a predetermined amount greater than zero.

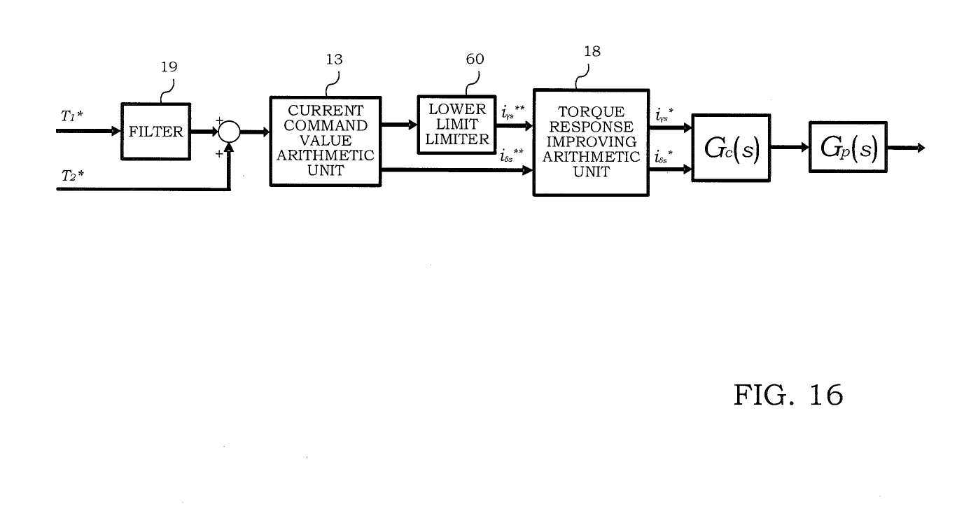

FIG. 16 is a block diagram showing a main configuration of the motor control apparatus according to the third embodiment. The same reference numerals are provided to the same elements as those of the configuration shown in FIG. 2, and their detailed explanation will be omitted.

In the motor control apparatus according to the third embodiment, a lower limit limiter 60 is provided in the subsequent stage of the current command value arithmetic unit 13. The lower limit limiter 60 carries out limiter processing in which the γ-axis current command value i_{γs} from the current command value arithmetic unit 13 becomes a predetermined lower limit or more. The predetermined lower limit is larger than zero. Namely, even though the target motor torque obtained by adding the target motor torque T1*, for which time delay processing was carried out, to the target motor torque T₂* is zero or in the vicinity of zero, the γ-axis current command value (the magnetic flux current command value) i_{γs}** with the slow response is set to become the predetermined lower limit, which is larger than zero, or more.

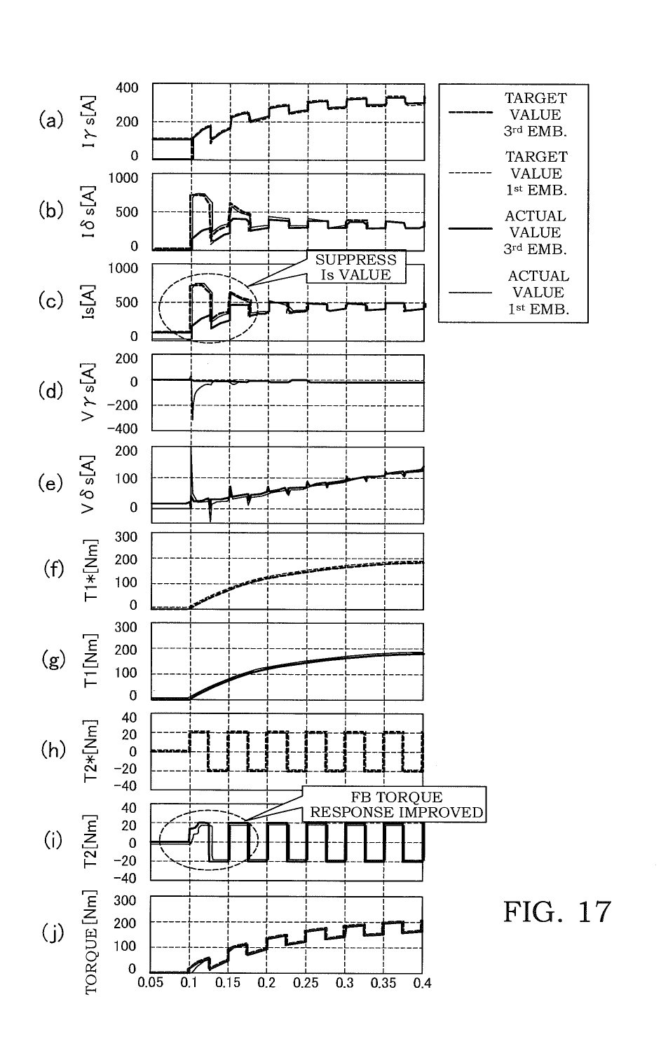

FIGS. 17(a)-17(j) show a controlled result of the motor control apparatus according to the third embodiment. However, for comparison, FIGS. 17(a)-17(j) also show the controlled result of the motor control apparatus according to the first embodiment. FIGS. 17(a) to 17(j) respectively denote the γ-axis current i_{γs}, the δ-axis current i_{δs}, the current vector Is, the γ-axis voltage Vγs, the δ-axis voltage Vδs, the feedforward torque command value T₁*, the feedforward torque actual value T1, the feedback torque command value T2*, the feedback torque T2, and the total torque. As described above, even though the target motor torque is zero or in the vicinity of zero, a magnetic flux current command value i_{γs}* with a slow response is set to become a predetermined lower limit, which is larger than zero, or more (see FIG. 17(a)). For this reason, it is possible to prevent a torque-axis current command value from becoming excessive when the magnetic flux is in the vicinity of zero, and it is possible to achieve a desired torque response by mitigating a delay of the magnetic flux (FIG. 17(i)).

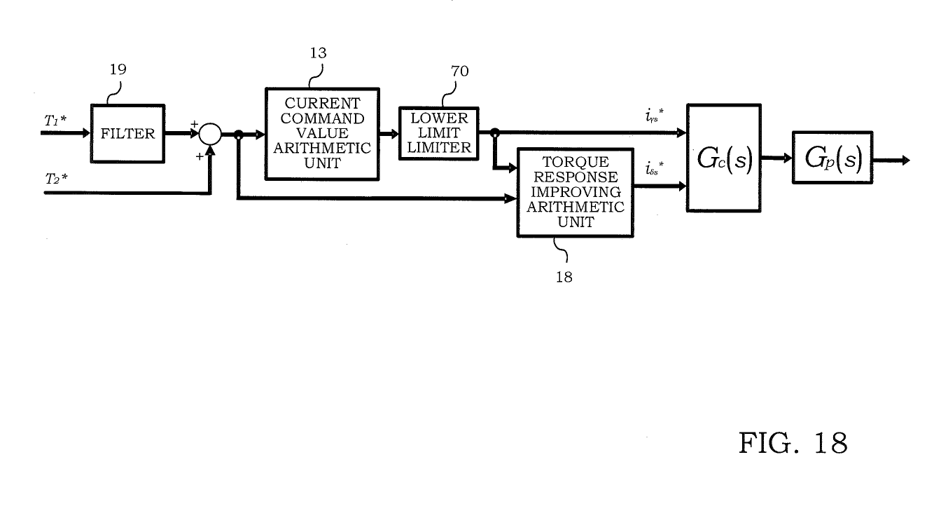

FIG. 18 is a block diagram showing a configuration of the case where a lower limit limiter 70 is provided in the configuration shown in FIG. 4. The lower limit limiter 70 operates so that the magnetic flux current command value i_{γs}* with the slow response becomes the predetermined lower limit, which is larger than zero, or more even though the target motor torque obtained by adding the target motor torques T1* and T₂* is zero or in the vicinity of zero. The limiter 70 carries out limiter processing so that the γ-axis current command value i_{γs}** outputted from the current command value arithmetic unit 13 becomes the predetermined lower limit or more.

### Reference Embodiment

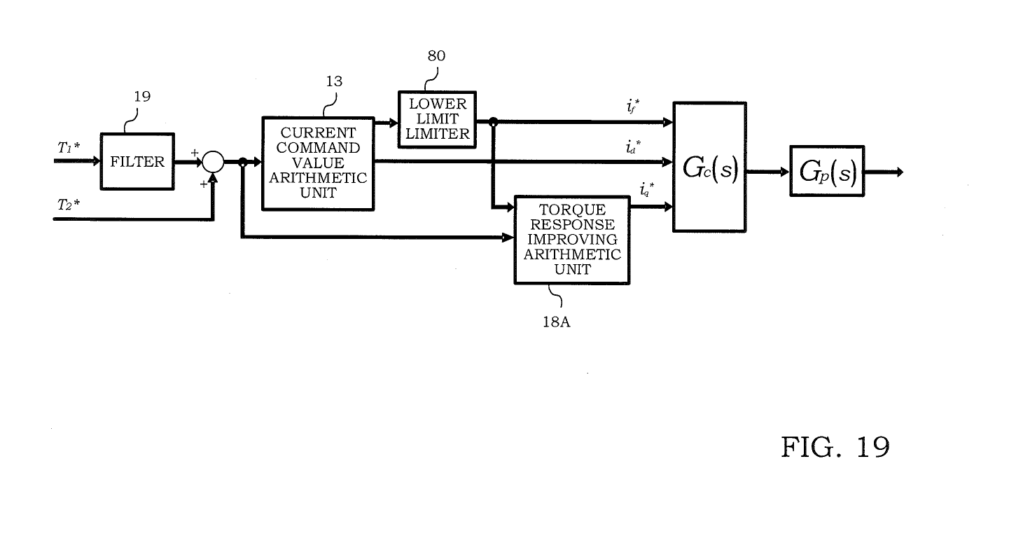

FIG. 19 is a block diagram showing a configuration of the case where a lower limit limiter 80 is provided in the configuration of the field-winding synchronous motor shown in FIG. 9 so that the field current i_{f}* with the slow response becomes the predetermined lower limit, which is larger than zero, or more even though the target motor torque obtained by adding the target motor torques T1* and T₂* is zero or in the vicinity of zero.

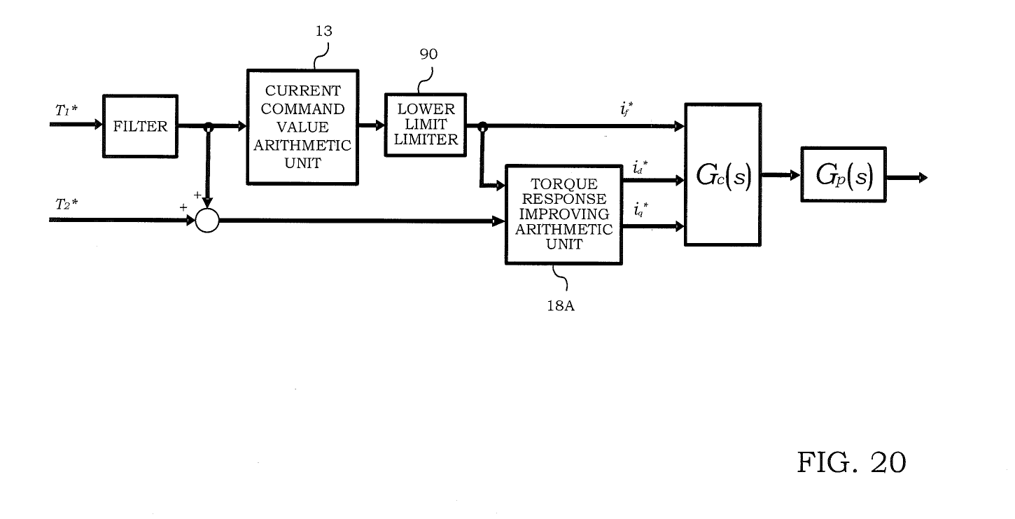

FIG. 20 is a block diagram showing a configuration of the case where a lower limit limiter 90 is provided in another configuration of the field-winding synchronous motor so that the field current i_{f}* with the slow response becomes the predetermined lower limit larger than zero or more even though the target motor torque obtained by adding the target motor torques T1* and T₂* is zero or in the vicinity of zero.

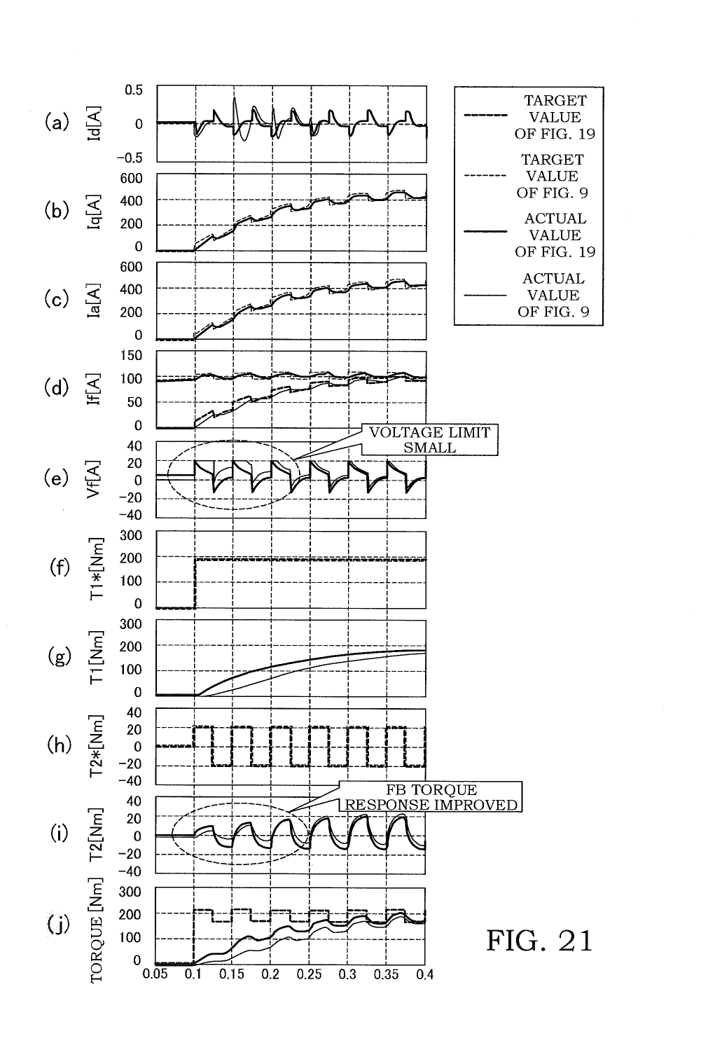

FIGS. 21(a)-21(j) show a controlled result of the configuration shown in FIG. 19. In FIGS. 21(a)-21(j), the controlled result of the configuration shown in FIG. 9 is also shown for comparison. FIGS. 21(a) to 21(j) respectively denote the d-axis current i_{d}, the q-axis current i_{q}, the current vector Ia, the field current I_{f}, the field voltage Vf, the feedforward torque command value T₁*, the feedforward torque actual value T1, the feedback torque command value T2*, the feedback torque T2, and the total torque. As described above, even though the torque command value T₁* is zero or in the vicinity of zero, the field current i_{f}* with the slow response is outputted by the predetermined amount greater than zero (see FIG. 21(d)). For this reason, it is possible to prevent the torque-axis current command value from becoming excessive when the magnetic flux is in the vicinity of zero, and it is possible to achieve the desired torque response (see FIG. 21(i)).

As described above, according to the motor control apparatus of the third embodiment, the magnetic flux current command value i_{γs}* is set to a predetermined value larger than zero or higher even in a case where the target motor torque is the predetermined torque or lower. For this reason, it is possible to prevent the torque-axis current command value from becoming excessive when the magnetic flux is in the vicinity of zero, and it is possible to achieve the desired torque response by mitigating a delay of the magnetic flux.

The present invention is not limited to the embodiments described above, and the present invention can be configured so that the features of the respective embodiments are combined appropriately, for example.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A motor control apparatus comprising:
an inverter that applies a voltage to an AC induction motor to be driven;
a command value calculator that calculates a command value of an AC voltage outputted from the inverter based on a target motor torque of the AC induction motor; and
an inverter controller that controls the inverter based on the command value of the AC voltage,
wherein the target motor torque of the AC induction motor includes a first target motor torque and a second target motor torque,
wherein a high speed response is required in the first target motor torque in order to at least suppress torsional vibration,
wherein the second target motor torque is a lower speed response than the first target motor torque,
wherein delay processing is carried out for the second target motor torque,
wherein the command value calculator calculates, based on the target motor torque, a magnetic flux current command value in which current responsiveness is slow with respect to an input, and
wherein the command value calculator calculates, based on the target motor torque and the magnetic flux current command value, a torque current command value in which current responsiveness is quicker than that of the magnetic flux current command value.

2. The motor control apparatus according to claim 1,
wherein the command value calculator calculates, based on the target motor torque, the torque current command value in which the current responsiveness is quicker than that of the magnetic flux current command value, and
wherein the command value calculator calculates a torque current command value after correction by correcting the calculated torque current command value based on the magnetic flux current command value.

3. The motor control apparatus according to claim 1, further comprising:
a limiter value calculator that calculates a limiter value based on at least one command value of the magnetic flux current command value and the torque current command value, and the maximum value of the current command value; and
a current command value limiter that limits the magnetic flux current command value or the torque current command value based on the limiter value.

4. The motor control apparatus according to claim 1,
wherein the command value calculator sets the magnetic flux current command value to a predetermined value larger than zero or higher even in a case where the target motor torque is a predetermined torque or lower.

5. A motor control method of controlling an AC induction motor by calculating a command value of an AC voltage outputted from an inverter based on a target motor torque of the AC induction motor and controlling the inverter based on the AC voltage,
wherein the target motor torque of the AC induction motor includes a first target motor torque and a second target motor torque,
wherein a high speed response is required in the first target motor torque in order to at least suppress torsional vibration,
wherein the second target motor torque is a lower speed response than the first target motor torque,
wherein delay processing is carried out for the second target motor torque, and
wherein the motor control method comprises:
calculating a magnetic flux current command value, in which current responsiveness is slow with respect to an input, based on the target motor torque when the command value of the AC voltage is calculated based on the target motor torque; and
calculating a torque current command value, in which current responsiveness is quicker than that of the magnetic flux current command value, based on the target motor torque and the magnetic flux current command value.
